(19) United States
(12) Patent Application Publication
(10) Pub. No.: US 2024/0324801 A1
(43) Pub. Date: Oct. 3, 2024

(54) CAKE COVER CANDLE HOLDER

(71) Applicant: Charles E Griffin, Inglewood, CA (US)

(72) Inventor: Charles E Griffin, Inglewood, CA (US)

(21) Appl. No.: 18/733,725

(22) Filed: Jun. 4, 2024

Related U.S. Application Data
(63) Continuation-in-part of application No. 16/747,727, filed on Jan. 21, 2020.

(51) Int. Cl. A47G 19/26; F21V 35/00

(52) U.S. Cl. CPC A47G 19/26; F21V 35/00

(57) ABSTRACT

A cake protector and candle holder lid is disclosed. The cake protector and single-use disposable plastic cake cover packaging includes a single sheet of transparent and disposable plastic cake lid, including an array of closed ended embossments piercing the surface of the cover for holding candles in an upright position.

### CROSS-REFERENCE TO RELATED APPLICATIONS

This continuation-in part application claims priority to U.S. application Ser. No. 16/747,727, titled “Cake Cover Candle Holder—CCCH”, filed Jan. 21, 2020, the entirety of which is incorporated here by reference.

### TECHNICAL FIELD

This disclosure relates to the field of food packaging, particularly focusing on hygienic solutions for cakes. Specifically, it relates to a range of transparent, disposable cake protectors and candle holder lids designed to enhance the presentation and safety of cakes during celebrations.

### BACKGROUND

Cake covers are known in the art. US 2005/0056162 (Milligan) pertains to a cake germ shield. US 2004/0244604 (Slagter) pertains to a protective food cover. Neither Milligan nor Slagter are tailored specifically for the cake packaging industry but serve more general purposes or are durable (non-disposable) designs. Milligan and Slagter are not optimized for single-use cake packaging, addressing hygiene concerns specific to celebratory events and adhering to unique FDA regulations and industry needs such as enhanced hygiene, display clarity, and convenience. Milligan's shield and Slagter's protective food cover fail to teach disposable, hygienic solutions which are needed to address the heightened consumer priorities for hygiene in the cake packaging industry brought about by the COVID-19 pandemic and its aftermath.

Traditionally, hygiene during candle blowing has been managed with separate products, such as disposable shields or covers used only during the celebration. Integrating these functions into a single product requires a novel approach that combines two or more distinct industry practices. This innovation necessitates cross-industry knowledge from food packaging, materials science, and public health. Such an interdisciplinary approach is often beyond the scope of professionals working strictly within the cake packaging industry.

The concept of integrating a hygienic candle-blowing function directly into cake packaging is driven by recent consumer insights and the market demand for more hygienic food-related products since the onset of C OVID-19. This novel concept was not obvious to those focused on traditional cake packaging designs within the industry

Therefore, a need exists for a cake packaging and candle holder to enhance hygienic celebratory practices.

### SUMMARY

In an aspect of the disclosure, a cake protector and candle holder lid is disclosed. The cake protector and candle holder lid includes a single sheet of transparent and disposable plastic cake lid, including an array of closed ended embossments piercing the surface of the cover for holding candles in an upright position.

In an aspect, the array of closed-ended embossments is specifically shaped and dimensioned to securely hold candles having varying diameters.

In an aspect, the cake lid comprises a circular, rectangular or square shaped cover to accommodate a diverse range of cake types and sizes.

In an aspect, the cake lid is designed to fit over an entire cake and protect the entire cake from contaminants when transporting and blowing out the candles.

In an aspect, the disposable cake lid and a securely fastened base are designed for cake packaging and intended for one-time use.

Other systems, methods, features and advantages of the invention will be, or will become, apparent to one with skill in the art upon examination of the following FIGURES and detailed description. It is intended that all such additional systems, methods, features and advantages be included within this description, be within the scope of the invention, and be protected by the following claims.

### BRIEF DESCRIPTION OF THE DRAWINGS

The invention can be better understood with reference to the following drawings and description. The components in the figures are not necessarily to scale, emphasis instead being placed upon illustrating the principles of the invention. Moreover, in the FIGURES, like referenced numerals designate corresponding parts throughout the different views.

FIG. 1 is a perspective view of a Cake Cover Candle Holder (CCCH), according to the disclosure.

### DETAILED DESCRIPTION

The disclosed Cake Cover Candle Holder (CCCH) addresses the hygiene and convenience issues associated with traditional cake lids and candle holders by integrating both functionalities into a single, disposable product, making it ideal for use during celebratory events. The CCCH is constructed from transparent, disposable PETE or similar FDA-compliant food-safe plastic material, which is chosen for its high clarity, rigidity, and safety, ensuring that the cake lid provides both an attractive display and a hygienic barrier.

The cake lid is available in various geometric configurations, including round and rectangular shapes, and multiple sizes to accommodate different types of cakes. A key feature of the CCCH is the incorporation of recessed, form-fitting wells on the top surface. These wells are designed to securely hold candles in an upright position, preventing them from tipping over and ensuring they are properly spaced. This design not only maintains the visual appeal of the cake but also enhances safety during candle lighting and blowing.

In operation, the CCCH acts as a barrier to catch spittle and other contaminants when candles are blown out, maintaining the cake's original sanitary condition. This feature is especially important during celebrations, where multiple people might be in close proximity to the cake. The CCCH ensures that blowing out candles on a cake is a safe and hygienic experience for all participants. Designed for single use, the CCCH is lightweight and can be easily disposed of after the event, eliminating the need for cleaning and reducing the risk of contamination from reuse.

A primary advantage of the disclosed CCCH is its dual functionality, combining cake protection and hygienic candle holding in a single product. This integrated approach addresses the limitations of existing solutions, which typically handle these functions separately. The invention responds to recent consumer demand for more hygienic food-related products. By providing a disposable, hygienic solution tailored specifically for the cake packaging industry, this invention offers significant benefits to cake bakers and distributors, improving hygiene standards and product convenience.

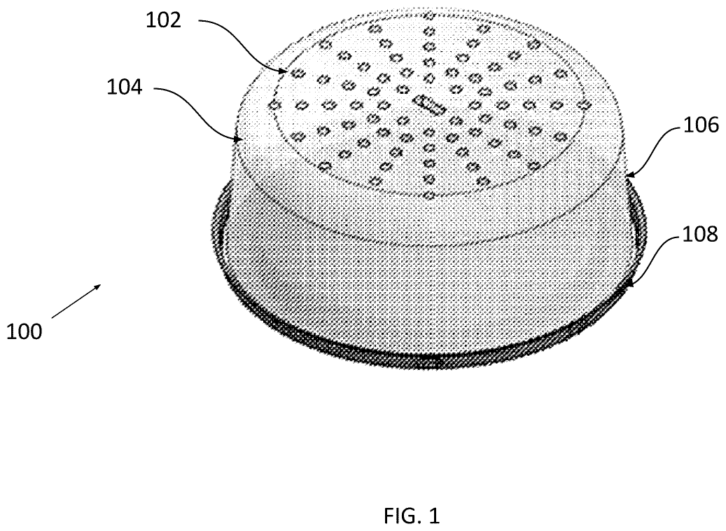

Referring now to FIG. 1, the Cake Cover Candle Holder (CCCH) 100 comprises a novel product offering consumers a practical solution to the aforementioned challenges. In an aspect of the disclosure, the CCCH 100 includes a single sheet of transparent and disposable plastic cake lid or dome. The CCCH 100 includes an array of closed ended embossments 102 piercing an outer surface 104 of the cake lid for holding candles in an upright position. In an aspect, the CCCH 100 includes a base 108 upon which a cake is placed for transportation and hygienic sealing from contaminants.

In an aspect of the disclosure, the disposable plastic cake dome may include an arrangement of closed ended wells protruding from a surface of a cover for holding one or more candles in a perpendicular angle.

In an aspect of the disclosure, the single sheet of transparent and disposable plastic cake lid comprises a plastic material formed from polyethylene terephthalate (PET or PETE). PETE plastic is clear, tough and has gas and moisture barrier properties. This plastic is commonly used for beverages such as soft drinks, juices and bottled water. It may be used for the transparent and disposable plastic cake cover because it allows for a cost-effective, disposable product that may be recycled and not added to environmental waste, yet satisfies the durability needed for the single use aspect of the transparent and disposable plastic cake cover and where the single sheet of transparent and disposable plastic cake cover comprises a plastic material formed from PETE. Other similar FDA-compliant food-safe, disposable, plastic material may be used by one of skill in the art, which is chosen for its high clarity, rigidity, and safety, ensuring that the cake lid provides both an attractive display and a hygienic barrier. Although PETE is not biodegradable, it is designed for single use and is preferred in the cake baker packaging industry because it is recyclable, making it an environmentally friendly option.

The PETE plastic used in the CCCH 100 complies with FDA regulations, specifically 21 CFR 177.1630, for single-use food contact materials. This ensures that the CCCH 100 meets stringent safety standards, making it suitable for hygienic cake packaging.

PETE or similar food-safe plastics are approved under 21 CFR 177.1630, which governs the use of materials in contact with food. This compliance underscores the safety and suitability of the disclosed CCCH 100 for its intended use.

Using FDA-approved food-safe plastic ensures that the CCCH 100 meets stringent safety standards, making it suitable for the cake bakery and cake distribution industry. Conventional food covers nowhere mention or disclose compliance with such standards.

The COVID-19 pandemic and increased public health awareness have significantly shifted consumer behaviors and expectations regarding hygiene, as evidenced by CDC guidelines on social distancing and safe celebrations. Recognizing and responding to these shifts with an integrated product demonstrates forward-thinking that may not be evident to industry professionals focused on pre-pandemic norms.

In an aspect, the CCCH 100 includes specially designed cake lid and base produced in both rectangular and circular versions and in several sizes. The CCCH cake packaging serves to protect the cake during transport and storage, and the transparent lids feature recessed, form-fitting wells for the candles, creating a germ-proof barrier between the candles (and the candle blower) and the cake. After the candles are blown out, the lid can be removed for cutting the cake.

In a further aspect of the disclosure, a rectangular version of the CCCH 100 is available in a variety of dimensions to accommodate different cake sizes, including but not limited to ⅛-sheet, ½-sheet, ⅔-sheet, and full-sheet cakes. The circular CCCH 100 depicted in FIG. 1 is also available in a variety of dimensions to accommodate different cake sizes, including but not limited to 6-12 inch diameter and 3.5-6.5 inches in height. Both versions feature a snap-sealing, locking, transparent disposable lid. The lids are designed not only to protect and seal the cakes but also to feature multiple, regularly spaced recesses or wells for the lid, with space in the middle for up to two single digit number candles or other party style candles. The disposable cake lid and a securely fastened base 108 are specifically designed for cake packaging and intended for one-time use. The single use plastic material provides high display clarity and sufficient rigidity to maintain the structure and function during use.

The user places the candles as desired in the wells 102 of the lid, then lights the candles to be blown out in the customary fashion before the lid is removed, and the cake is cut and consumed. The transparent nature of the lid allows everyone to enjoy the cake's decoration while the candles are blown out. With the design of the CCCH 100, the candles are placed in the top of the lid, never touching the cake, thus ensuring that no candle wax or the candle blower's saliva reaches the surface of the cake.

When the candles are blown out, the CCCH 100 prevents person-to-cake transmission of germs, keeping the cake hygienic. Additionally, the CCCH 100 protects the cake from insects, dust, and other contaminants. After the cake is eaten, the user can dispose of or recycle the thin plastic CCCH 100, which is made from PETE or similar FDA-compliant food-safe plastic, a recyclable material preferred in the cake baker packaging industry.

While various embodiments of the invention have been described, it will be apparent to those of ordinary skill in the art that many more embodiments and implementations are possible within the scope of the invention. Accordingly, the invention is not to be restricted except in light of the attached claims and their equivalents.

What is claimed is:

1. A cake protector and candle holder lid comprising:
a single sheet of transparent and disposable plastic cake lid, comprising an array of closed ended embossments piercing the surface of the cover for holding candles in an upright position and where the single sheet of transparent, disposable and recyclable, plastic cake cover lid comprises a plastic material formed from PETE or FDA-compliant food-safe plastic material.

2. The cake protector and candle holder lid of claim 1, where the array of closed-ended embossments are specifically shaped and dimensioned to securely hold candles having varying diameters.

3. The cake protector and candle holder lid of claim 1, where the cake lid comprises a circular, rectangular or square shaped cover to accommodate a diverse range of cake types and sizes.

4. The cake protector and candle holder lid of claim 1, where the cake lid is designed to fit over an entire cake and protect the entire cake from contaminants when transporting and blowing out the candles.

5. The cake protector and candle holder lid of claim 1, where the disposable cake lid and a securely fastened base are designed for cake packaging and intended for one-time use.
